(19) United States
(12) Patent Application Publication
(10) Pub. No.: US 2017/0357957 A1
(43) Pub. Date: Dec. 14, 2017

(54) FACILITATING AUTHENTICATION FOR ONLINE PAYMENT

(71) Applicant: Razorpay, Inc., Palo Alto, CA (US)

(72) Inventors: Shashank Mehta, Koramangala (IN); Pranav Gupta, Koramangala (IN); Shashank Kumar, Koramangala (IN)

(21) Appl. No.: 15/616,570

(22) Filed: Jun. 7, 2017

(30) Foreign Application Priority Data
Jun. 10, 2016 (IN) 201641020023

(51) Int. Cl. G06Q 20/12; G06Q 20/40; G06Q 30/06

(52) U.S. Cl. CPC G06Q 20/12; G06Q 30/0635; G06Q 20/4014

(57) ABSTRACT

Facilitating authentication includes providing a first page to a user interface based on an order received from a merchant page. Payment details are received from the first page for a first level of authentication and a second page is provided to the user interface for a second level of authentication. The second page is provided while keeping the first page open in the user interface with the payment details populated therein. A transaction result status is received from a payment-processing infrastructure based on the first and second level of authentication. When the transaction result status indicates failure, a modified first page is created to include the payment details previously populated for an online payment and at least one of a retry button and a field indicating a reason for transaction failure.

### TECHNICAL FIELD

The present subject matter relates, in general, to authentication of a user for online payment in a network environment and, in particular, to facilitating authentication of a user for 3D secure online payments.

### BACKGROUND

In the recent past, there has been a widespread increase in the popularity of e-commerce as more and more people are using smartphones, tablets, and other internet enabled computing devices. There exist many merchants offering to sell items and services over the internet using, for example, online shopping websites, e-commerce portals, mobile applications, etc. These portals provide an easy platform for online trading. While conducting such transactions, users typically have to provide their bank account details or debit or credit card details for making online payments. This may expose the users to the risk of online fraud, which also affects the merchants and the banks involved. As a result, multi-factor authentication mechanisms, such as 3D secure payment, have been developed and are increasingly being made mandatory for use in e-commerce transactions by regulators in various countries.

### BRIEF DESCRIPTION OF DRAWINGS

The detailed description is described with reference to the accompanying figures. In the figures, the left-most digit(s) of a reference numeral identifies the figure in which the reference numeral first appears. The same numerals are used throughout the drawings to refer like features and components.

FIGS. 1(a) and 1(b) illustrate example schema for authentication of online payments, in accordance with various implementations of the present subject matter.

FIG. 2 illustrates an example network environment for authentication of online payments, in accordance with an implementation of the present subject matter.

FIGS. 3(a) to 3(e) illustrate screenshots of user interface during authentication of online payments, in accordance with various implementations of the present subject matter.

FIG. 4 illustrates an example method for authentication of online payments, in accordance with an implementation of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes, which may be substantially represented in computer readable medium and so executed by a computing device or processor, whether or not such computing device or processor is explicitly shown.

### DETAILED DESCRIPTION

The subject matter disclosed herein relates to system(s) and method(s) to facilitate authentication for online payment. To make e-commerce reliable and to reduce online fraud, two-step authentication, also known as 3D Secure, was introduced for online transactions. 3D Secure requires a user to provide, apart from card details, net-banking details, or wallet information, a second authentication detail, such as a One-Time Password (OTP) or a predefined password, which is authenticated directly by the bank or financial institution of the user.

So far, the technique of two-step authentication has been handled through web page redirects, whereby a user may fill payment details on a web page, which could be on the merchant's own site or on a payment service provider's site. Next, the user gets redirected from the web page with payment details to a 3D secure page or an OTP page provided by a bank, where the second level authentication details are entered by the user for authentication. Finally, upon validation or rejection of the transaction by the bank on the 3D secure page, the user gets redirected to the merchant's web page. The redirected merchant's web page on which the user is notified of the result of the authentication is typically different from the web page on which the payment details were entered.

Thus, in the above described process, even in case the authentication at the 3D secure page fails, the user is redirected to a web page different from the web page with the payment details. As a result, the user would have to again initiate the transaction, fill the payment details, and would again get redirected for the second level authentication. It will thus be appreciated that, in case of failure, when the process is to be repeated one or more times, the processor cycles consumed in the previous iteration(s) are wasted.

In case the merchants would like to retain the payment details so that the user does not have to enter all the details again, Payment Card Industry Data Security Standard (PCI DSS) certified payment detail saving technologies have to be used by the merchants. This adds to the cost and complexity of the technology to be used at the merchant end.

Further, the redirections use multiple message exchanges amongst network resources, leading to an increase in network traffic and affecting other users. Such use of network and system resources may prove costly to the merchant and the user alike. For example, in the case of slow speed networks, temporary network failures, or mobile transactions, it can lead to an increase in the failure or abandonment of transactions.

The present subject matter describes system(s) and method(s) for facilitating online payments. The systems and the methods of the present subject matter are capable of performing a two-step authentication process with substantially reduced number of redirections. In accordance with an implementation, a first web page may be a web page having payment details of a user. Further, the first web page may be always open and accessible, thus, eliminating the problems faced due to redirection to a different web page from the first web page for the second level of authentication. It will be understood that the redirections required during the second level of authentication may not be affected as they are typically bank/financial institution controlled. However, the redirections from the first web page are substantially reduced/eliminated.

While the term web page has been used to refer to a page presented on a user interface, it will be understood that the web page may be a page of a website or a page/interface of a mobile application (app) or the like. Further, the web page may be generated in the form of a popup window or an inline frame (iframe) in another web page. Accordingly, the terms web page and page will be used interchangeably in the following description.

In operation, a user may place an order on a merchant web page, such as a page of a website or an app of the merchant, displayed on a user device by a merchant front-end component. The merchant front-end component can communicate with a merchant back-end component on a merchant system to fetch and display information to the user and receive inputs from the user.

Further, the merchant front-end component and/or the merchant back-end component can be associated with a payment gateway component for processing of online payment, including authentication. The payment gateway component of the present subject matter facilitates the authentication of online payment with minimal redirections, as will be discussed in detail herein. The payment gateway component can in turn interface with a payment-processing infrastructure at the back-end for carrying out the online payment transactions.

It will be understood that the payment-processing infrastructure may be standard infrastructure involving various access control servers (ACS), banking systems, merchant plug-ins (MPI), etc. and is not described in detail for brevity. It will be also understood that the user will interact with the merchant front-end component and/or the payment gateway component and infrastructure through a user interface of a user device.

Once the purchase is initiated by the user on the merchant web page, a first web page may be provided to the user, by either the payment gateway component or the merchant front-end component, to enter payment details for the online transaction. In one embodiment, if the payment gateway component provided the first web page, it receives the payment details back directly for processing. In another embodiment, if the merchant front-end component provided the first web page, the merchant front-end component receives the payment details and sends it to the payment gateway component for processing. Thus, in either case, the merchant back-end component does not process the payment details or have access to it. Thus, the merchant back-end component is isolated from handling any payment details of the user, thereby making the transaction more secure and eliminating the need for the merchant back-end component to implement complex PCI certified technology.

Upon receipt of the payment details, if the payment gateway component determines that the payment is to be authenticated by a 3D secure mechanism, the payment gateway component generates a second web page. The second web page is presented to the user while the first web page also remains open, in the background or on a different iframe, with the payment details present therein. On the second web page, the 3D secure page of a bank/financial institution is presented, where the user is prompted to provide authentication details, which are processed by the payment-processing infrastructure. Upon successful authentication, the transaction proceeds to completion.

However, upon failure of authentication on the second web page, the payment gateway component or the merchant front-end component, as the case may be, receives a transaction failure message and the user may be then presented with a modified first web page. In such a case, the second web page alone may be automatically closed or manually closed by the user. The modified first web page may correspond to the first web page with payment details previously filled in by the user and an additional option to re-perform the transaction using the previously filled in data. Further, the user may be allowed to edit the previously filled in data before re-performing the transaction.

Thus, the present subject matter provides for retaining the previously filled in data, such as payment details, in the first web page in case of transaction failure, such as network failure, bank server overload, bank server down, and the like. For example, in case of network failure, the second web page itself may not load completely and so, the user may close the second web page. When the second webpage is closed, the modified first web page may be presented to the user. In another example, in case the bank's portal is down, the second web page may show an error and the user may be able to close the second web page, view the payment details on the modified first web page, and retry to make the payment.

The two-step authentication for online payment based on retaining of the previously filled payment details in the first web page and authentication on a second web page makes the systems and the methods of the present subject matter more reliable, faster, user friendly, and cost effective. Thus, the system saves the excessive usage of system and network resources for filling-in the payment details iteratively. Further, as there is no redirection from the first web page, network traffic, computational resources, and time consumed are substantially reduced. Moreover, since the details are present in the first web page, which is controlled by either the payment gateway or the merchant front-end component, and are not stored anywhere, it does not compromise the security of the transaction.

The manner in which the system(s) and method(s) shall be implemented has been explained in detail with respect to the appended figures. Although the description herein is provided with reference to certain example implementations, the method(s) and system(s) may be implemented in other any number of different computing devices, transmission environments, and/or configurations, as well, albeit with a few variations, as will be understood by a person skilled in the art.

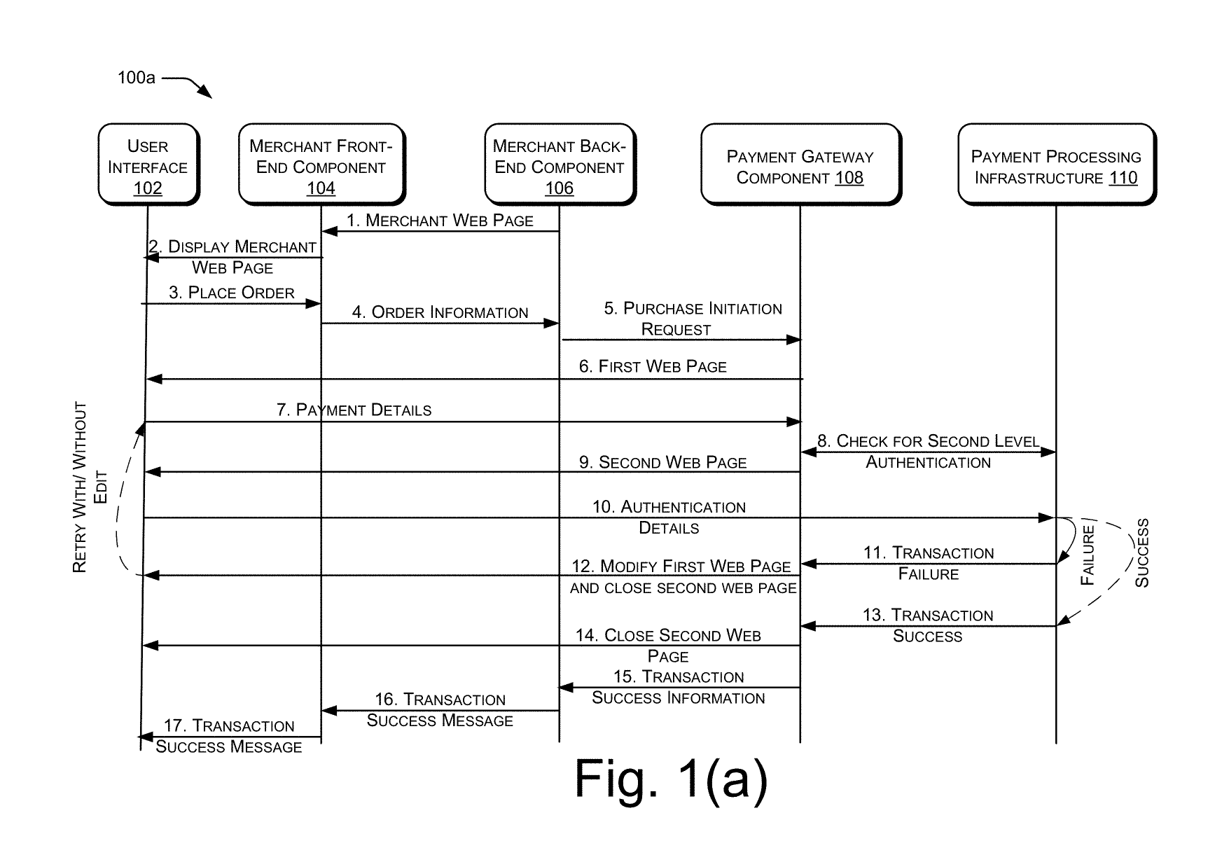

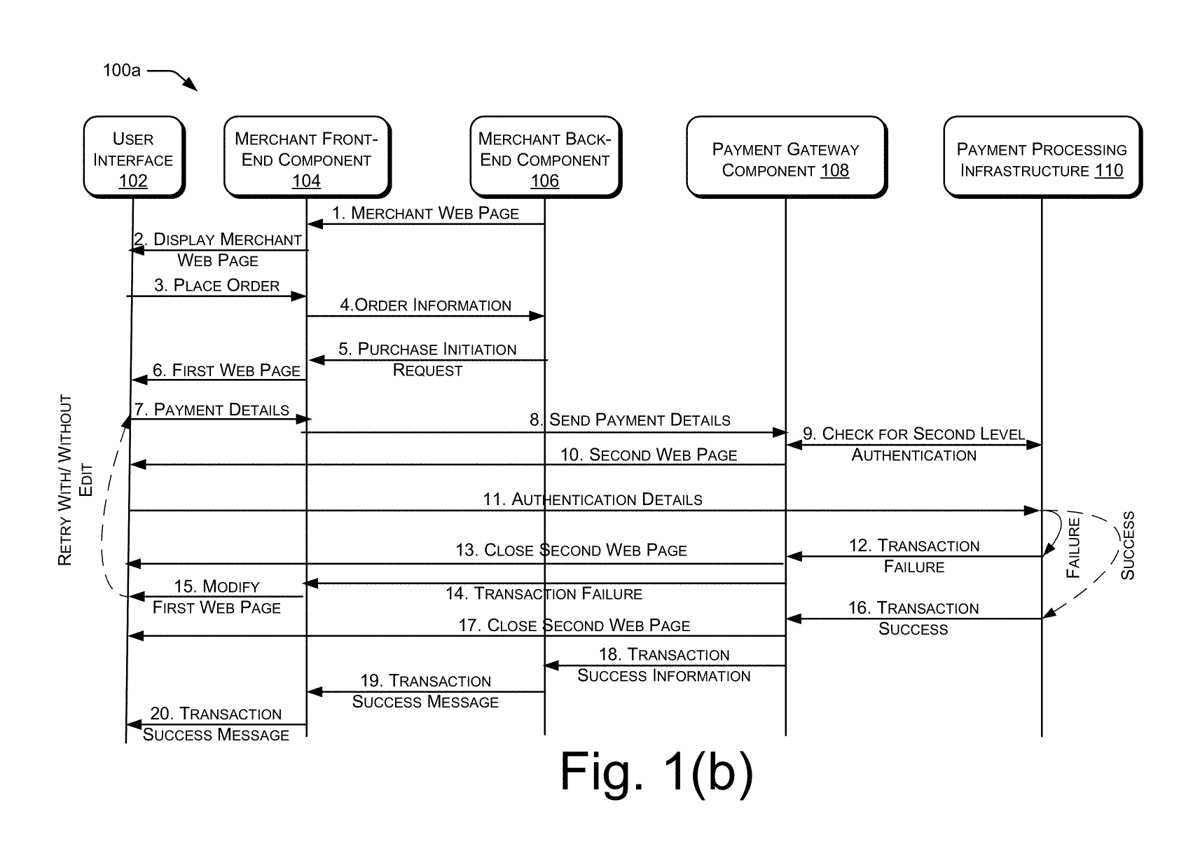

FIGS. 1a and 1b illustrate example schema 100a and 100b respectively for authentication of online payments, in accordance with various implementations of the present subject matter. The schema 100a and 100b illustrate example flow of steps that take place between a user interface 102, a merchant front-end component 104, a merchant back-end component 106, a payment gateway component 108, and payment-processing infrastructure 110.

It will be understood that, for the sake of readability, various specific messages that may be exchanged, for example, for setting up sessions, transferring data, encryption and decryption of data, etc., are not illustrated. However, based on the teachings provided by the schema 100a and 100b, a person skilled in the art can easily implement the various messages using protocols known in the art.

Further, it will be understood that while some of the steps shown in the schema 100a and 100b may be executed sequentially, some may be performed in parallel. Accordingly, the order of the steps is not to be construed as being limiting.

Rather, a person skilled in the art may be able to devise certain modifications to come up with an equivalent schema and all such equivalent schema are meant to be covered under the scope of the present disclosure and claims.

Referring to FIG. 1a, schema 100a illustrates an embodiment where, for purchase initiation, the control goes from the merchant back-end component 106 to the payment gateway component 108 directly and the payment gateway component108 controls the first web page. However, the purchase initiation request can be sent from the merchant front-end component also, based on communication between the merchant front-end component and the merchant back-end component 106, as would be understood by a person skilled in the art.

In the embodiment of schema 100a, at step 1, the merchant back-end component 106 may provide a merchant web page to the merchant front-end component 104 for display on the user interface 102. The merchant front-end component 104 can be, for example, a merchant website or a merchant app being browsed by the user on the user interface 102. The user interface 102 may be associated with a user device (not shown in this figure), such as a mobile device, a laptop, a computing system, and the like, which is operated by the user for conducting online transactions.

At step 2, the user interface 102 can receive and display the merchant web page to the user. The user may then place an order on the user interface, by, for example, selecting/clicking on a “buy” button corresponding to a particular item or service that the user may want to purchase from the merchant. At step 3, the user, through the user interface 102, places an order with the merchant front-end component 104, which sends the order information to the merchant back-end component 106 at step 4. Through the order information, the merchant back-end component 106 records that the user is interested in making a purchase and identifies the product/service to be purchased (i.e., order to be fulfilled). Thus, the merchant system can later track and reconcile the purchase. Further, at step 5, the merchant back-end component 106 can invoke the payment gateway component 108 with a purchase initiation request providing purchase details. For example, the selection of the “buy” button on the merchant front-end component 104 may cause a JavaScript to be executed to send the order information to the merchant back-end component 106, which in turn sends the purchase initiation request to the payment gateway component 108.

In another implementation (not shown), the merchant back-end component 106 may communicate the purchase details to the merchant front-end component 104, which may then send the purchase initiation request to the payment gateway component 108.

The purchase initiation request can include information/purchase details about the cost of the purchase, item code to be purchased, etc., based on which the payment gateway component 108 can facilitate authentication and payment processing in the further steps. Thus, the merchant back-end component 106 can be isolated from handling any payment related details. Further, the payment gateway component 108 can implement encryption and other security measures to comply with PCI standards and maintain data security.

At step 6, in response to the purchase initiation request, the payment gateway component 108 can present a first web page to user interface 102 for display to the user. The first web page can include, for example, a checkout form, where the user can be asked to provide billing information, such as email id and phone number, and can be asked to select a mode of payment, for example, from credit card, debit card, internet banking, and digital wallet. Based on the selected mode of payment, the first web page can show one or more fields for entry of payment details, such as card or account number, user id, card expiry date, and the like.

At step 7, the various payment details are received from the user interface 102 by the payment gateway component 108 for processing. The payment details form the first level of authentication. In turn, at step 8, the payment gateway component 108 communicates with the payment-processing infrastructure 110 for checking whether a second level authentication is required and the network address or uniform resource locator (URL) of the authentication entity, such as an access control server, that will be performing the second level authentication. The second level authentication refers to a 3D secure authentication, during which, for example, a pre-defined password or an OTP is verified to authenticate the user interface 102.

It will be understood that, in a first scenario, where the second level authentication is not required, for example, because the bank or card issuing authority or the mode of payment selected does not support it, the payment-processing infrastructure 110 authenticates the payment details to proceed with the transaction, as is known in the art. Thus, the present subject matter can also be made compatible with systems that may not use the second level authentication. Accordingly, though it is not shown, it will be understood that depending on transaction success or failure based on the payment details, the flow may move from step 8 to step 11 or step 13 respectively in such a scenario.

In a second scenario, as illustrated, where the second level authentication is required, the flow proceeds from step 8 to step 9. At step 9, the payment gateway component 108 presents a second web page to the user interface 102. In the second web page, the URL/web page of the server that will be performing the second level authentication is opened and presented to the user through the user interface 102. The second web page is opened in addition to the first web page and is not a redirection from the first web page. Thus, the first web page with the payment details entered therein by the user remains open and available while the further processing happens. Further, the second web page is opened separately and there is no redirection from the first web page, thus alleviating the issues associated with a high number of redirections.

At step 10, once the user enters the authentication details, such as the pre-defined password or the OTP, on the second web page, the authentication details are sent to the payment-processing infrastructure 110 from the user interface 102. Then, at the back-end, the payment-processing infrastructure 110 authenticates the user interface 102 based on the payment and authentication details, and authorizes the payment transaction. The payment-processing infrastructure 110 then provides a transaction result status that is indicative of a combined result of the first level of authentication, the second level of authentication, and the online payment. In case the payment or authentication details are incorrect or for some reason the transaction fails, for example, due to a server or network being down, the payment-processing infrastructure 110 provides a transaction failure message to the payment gateway component 108 at step 11. However, if the authentication succeeds and the transaction proceeds to completion, the flow moves to providing a transaction success message to the payment gateway component 108 at step 13.

Considering first the case where the transaction fails, on receiving the transaction failure message at step 11, the payment gateway component 108 modifies the first web page and closes the second web page if the second web page is open at step 12. The second web page may have closed automatically upon transaction failure or may have been closed by the user already. If not, the payment gateway component 108 can cause the second web page to close. Further, the instructions to modify the first web page can be in the form of a JavaScript code that adds fields to the first webpage or overlays fields over the first web page. The fields added/overlaid can include a message indicating reason for failure, such as password error or server not responding. Further, the fields added/overlaid may include a retry button.

The user may then, through the user interface 102, retry performing the payment using the previously entered payment details or may edit the payment details and retry performing the payment. In either case, it will be appreciated that the user does not have to re-enter all the details, thereby saving on time and resource usage. Further, since there are no redirections involved from the first web page, the whole process happens much faster and more reliably. When the user retries to perform the payment, the flow moves back to step 7 where the payment details are sent to the payment gateway component 108 and it proceeds as discussed above.

While not illustrated, it will be understood that in case the user decides not to retry performing the transaction or attempts to abandon the transaction at any point, for example, by closing the first and/or second web pages, the payment gateway component 108 may send a transaction failure message to the merchant back-end component 106 and end the flow.

Now considering the case where, after receiving authentication details at step 10, the payment-processing infrastructure 110 succeeded in authentication of the user and the payment transaction was completed successfully. Then a transaction success message is received by the payment gateway component 108 at step 13 and it causes at least the second web page to close at step 14. In one example, the first web page may remain open for displaying a transaction success message provided in subsequent steps. In another example, the first web page 302 may also be closed and the transaction success message may be displayed on a different page.

Further, at step 15, the payment gateway component 108 sends transaction success information to the merchant back-end component 106. The transaction success information can include identifiers for the transaction, which can be used by the merchant back-end component 106 to track and verify the purchase and capture the payment. The process of payment capture by the merchant is well understood in the art and hence is not explained herein. A transaction success message is also sent from the merchant back-end component 106 to the user interface 102 through the merchant front-end component 104, at steps 16 and 17, to notify the user that the payment transaction has been completed successfully.

Referring to FIG. 1b, schema 100b illustrates another embodiment where, the merchant back-end component 106 controls the first web page and control is transferred to the payment gateway component 108 after the user enters the payment details on the user interface 102. For the sake of brevity, only the steps that are different from the schema 100a are described. It will be understood that the other steps will be carried out in a manner as described earlier.

In this embodiment, at step 5, upon receiving the order information, the merchant back-end component 106 can provide the purchase initiation request to the merchant front-end component 104. At step 6, the merchant front-end component 104 provides the first web page to the user interface 102 instead of the payment gateway component 108 providing the first web page (as was done in the previous implementation discussed with reference to FIG. 1(a)).

For example, the selection of the “buy” button on the merchant front-end component 104 may cause a JavaScript to be executed to send the order information to the merchant back-end component 106, which in turn sends the purchase initiation request to the merchant front-end component 104. The merchant front-end component 104 then sends the first web page to the user interface 102. As described earlier, the first web page can include, for example, a checkout form, where the user can be asked to provide billing information, such as email id and phone number, and can be asked to select a mode of payment, for example, from credit card, debit card, internet banking, and digital wallet. Based on the selected mode of payment, the first web page can show one or more fields for entry of payment details, such as card or account number, user id, card expiry date, and the like.

At step 7, the payment details are received from the user interface 102 by the merchant front-end component 104 and at step 8, the payment details are provided to the payment gateway 108. The merchant back-end component 106 is thus again isolated from handling the payment details, thereby ensuring security of the transaction. Further, the payment gateway component 108 can implement encryption and other security measures to comply with PCI standards and maintain data security.

After the payment details are received by the payment gateway component 108, the steps 9-11 for second level authentication occur as explained earlier. Further, depending on whether the second level authentication is a success or failure, the flow passes on step 12 or 16 accordingly. In case of a transaction failure, the payment gateway 108 can cause the second web page to be closed at step 13 and can provide the transaction failure message to the merchant front-end component 104 at step 14. The merchant front-end component 104 may either provide a modified first web page at step 15 to allow the user to retry the transaction as discussed earlier or may choose to close the first web page. Accordingly, the flow may move to step 7 as shown in the figure or to step 2.

In case of transaction success, the transaction success message is received at step 16 by the payment gateway component 108, which can cause the second web page to close at step 17 and then pass the transaction success message to the merchant front-end component 104 through the merchant back-end component 106 at steps 18 and 19. At step 20, the merchant front-end component (104) can display the transaction success message through the user interface 102. As discussed earlier, the transaction success message may be displayed on the first web page or on a different web page.

The user authentication for online payment outlined in the schema 100a and 100b may be implemented in various network environments. The various components (104, 106, 108) may be implemented on one or more computing systems that communicate with each other over a communication network in the network environments. The payment-processing infrastructure 110 can also communicate over the communication network in such network environments.

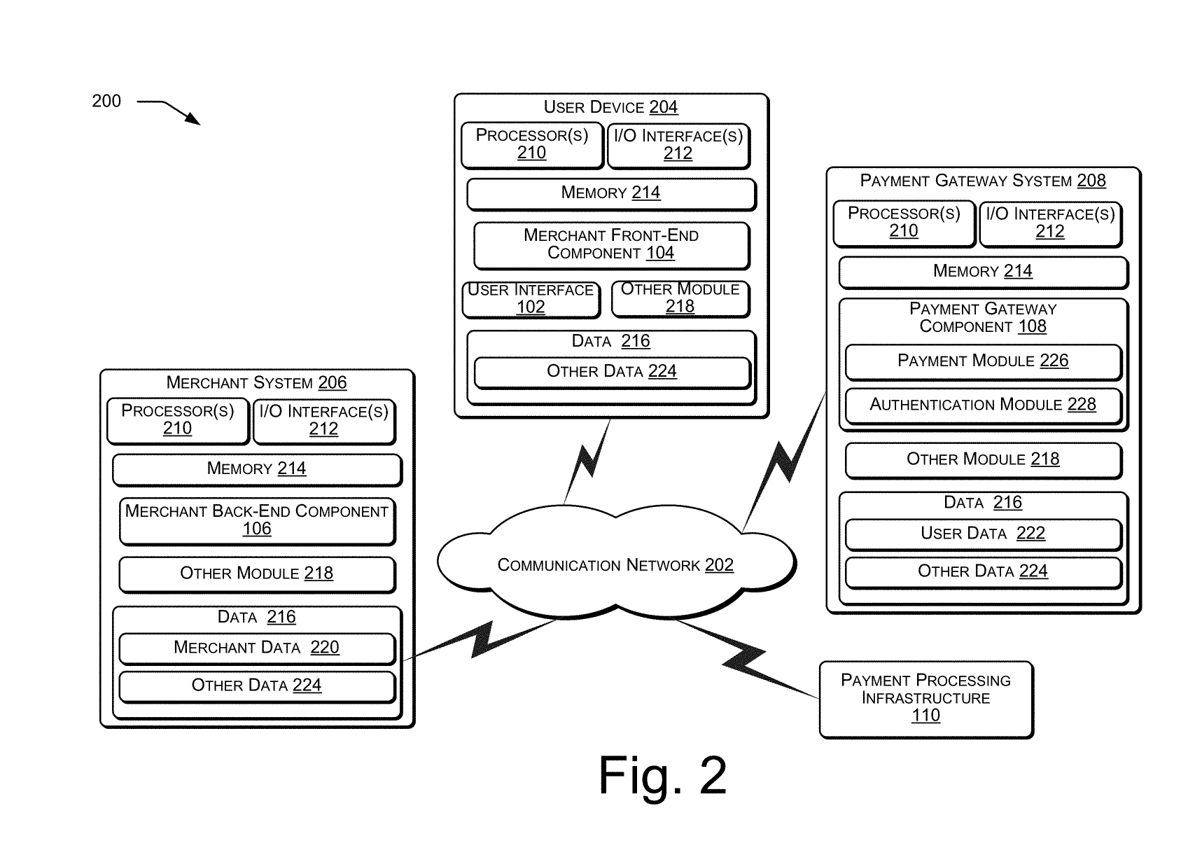

FIG. 2 illustrates an example network environment 200 for authentication of online payments over a communication network 202, in accordance with an implementation of the present subject matter. The communication network 202 may be a wireless network, a wired network, or a combination thereof. The communication network 202 can also be an individual network or a collection of many such individual networks, interconnected with each other and functioning as a single large network, e.g., the Internet or an intranet, and can be implemented as any of the different types of networks, such as intranet, local area network (LAN), wide area network (WAN), and their combinations. The communication network 202 may also include individual networks, such as but not limited to, Global System for Communication (GSM) network, Universal Telecommunications System (UMTS) network, Long Term Evolution (LTE) network, etc.

The network environment 200 further includes a user device 204 on which the merchant front-end component 104 and the user interface 102 are implemented, a merchant system 206 having the merchant back-end component 106, a payment gateway system 208 having the payment gateway component 108, and the payment-processing infrastructure 110. The network environment 200 may also include other devices/systems connected over the communication network 202, such as other user devices 204 and other merchant systems 206, which are not shown for brevity.

The user device 204, the merchant system 206, and the payment gateway system 208 may be implemented in a variety of computing systems, such as a laptop computer, a desktop computer, a notebook, a workstation, a server, a mobile device, and the like. While the user device 204, the merchant system 206, and the payment gateway system 208 have been shown to be implemented in different computing systems, it will be understood that any two of them or all three of them can be integrated/co-implemented on a single computing system in different embodiments. In yet other embodiments, one or more of them can be implemented on distributed computing systems.

Considering the illustrated network environment 200, each of the user device 204, the merchant system 206, and the payment gateway system 208 can include respective processor(s) 210. The processors 210 may be implemented as one or more microprocessors, microcomputers, microcontrollers, digital signal processors, central processing units, state machines, logic circuitries, and/or any devices that manipulate signals based on operational instructions. Among other capabilities, the processors 210 are configured to fetch and execute computer-readable instructions stored in a memory 214.

Further, each of the user device 204, the merchant system 206, and the payment gateway system 208 can include respective I/O interface(s) 212. The interfaces 212 may include a variety of machine readable instruction-based and hardware-based interfaces that allow communication with a user, with each other, and with other devices, and network entities, including servers, data sources, and external repositories. For example, the interfaces 212 may include a touch screen, a keypad, a wireless network interface, an Ethernet interface, etc.

Further, each of the user device 204, the merchant system 206, and the payment gateway system 208 can include respective memory 214. The memory 214 may be coupled to the respective processor(s) 210. The memory 214 can include any non-transitory computer-readable medium known in the art including, for example, volatile memory, such as static random access memory (SRAM) and dynamic random access memory (DRAM), and/or non-volatile memory, such as read only memory (ROM), erasable read only memory (EROM), erasable programmable ROM, flash memories, hard disks, optical disks, and magnetic tapes and can store instructions corresponding to one or more modules.

Further, each of the user device 204, the merchant system 206, and the payment gateway system 208 can include respective modules, such as the user interface 102, the merchant front-end component 104, the merchant back-end component 106, the payment gateway component 108, and other modules 218. Similarly, they can include respective data 216. The modules and the data 216 may be coupled to the respective processor(s) 210. In an implementation, the other modules 218 may include programs or coded instructions that supplement applications or functions performed by respective device/systems, such as operating systems and other installed applications.

The modules, amongst other things, include routines, programs, objects, components, data structures, etc., which perform particular tasks or implement particular abstract data types. The modules may also be implemented as, signal processor(s), state machine(s), logic circuitries, and/or any other devices or components that manipulate signals based on operational instructions. Further, the modules can be implemented in hardware, as instructions executed by a processing unit, or by a combination thereof. In another aspect of the present subject matter, the modules may be machine-readable instructions which, when executed by a processor/processing unit, perform any of the desired functionalities. The machine-readable instructions may be stored on an electronic memory device, hard disk, optical disk or other machine-readable storage medium or non-transitory medium. In an implementation, the machine-readable instructions can also be downloaded to the storage medium via a network connection.

The data 216 serves, amongst other things, as a repository for storing data 216 that may be fetched, processed, received, or generated by the modules. For example, the data 216 in the merchant system 206 may include merchant data 220 where inventory, availability, price, and other details related to the items or services provided by the merchant may be stored.

Although the data 216 is shown internal to the each of the devices/systems, it may be understood that some of the data 216 can reside in external repositories (not shown in the figure), which may be coupled to the communication network 202. In the above implementation, the data 216 can also include other data 224, which amongst other things, may serve as a repository for temporarily or permanently storing data that is processed, received, or generated as a result of the execution of one or more modules in respective devices/systems.

In operation, as discussed above, the payment gateway component 108 can receive payment details from a first page displayed on the user interface 102. The first page itself may be controlled by either the merchant front-end component 104 or the payment gateway component 108, as discussed above. Based on the payment details, the payment gateway component 108 can provide a second page to the user interface 102 for connecting to the authentication entity for 3D secure authentication. As discussed, the second page is to be presented in addition to the first page while the first page remains open with the payment details populated in the first page. Thus, the second web page is not a redirection from the first web page. Through the second page, the user can provide 3D authentication details to the payment-processing infrastructure 110 for authentication and payment authorization.

The payment gateway component 108 can then receive a transaction result status from the payment-processing infrastructure 110 based at least on the payment details and the 3D secure authentication, where the transaction result status is indicative of success of the online payment. When the transaction result status indicates failure, the payment gateway component 108 or the merchant front-end component 104 can cause the first page to be modified to provide a modified first page, where the modified first page includes the payment details previously populated for the online payment and at least one of a retry button and a reason for failure. The user can then retry sending the payment details with or without edit, with minimal effort.

In one implementation, to perform the above tasks, the payment gateway component 108 may include a payment module 226 for providing the first page and communicating with the merchant system 206 and the user device 204; and an authentication module 228 for providing the second page and communicating with the payment-processing infrastructure 110. Further, if the user desires, the payment gateway component 108 may store the payment details of the user securely in user data 222 for future transactions.

In another implementation (not shown), the payment module 226 may be implemented in the merchant front-end component 104 for providing the first page while the authentication module 228 may be implemented in the payment gateway component 108 for facilitating the second level authentication.

While the network environment 200 has been described as an example implementation, it will be understood that various other implementations are also possible. For example, consider an implementation where the user device 204 is a mobile device and the online transaction is undertaken by a user through the merchant front-end component 104 installed on the user device 204 as an app. In such a case, the payment gateway component 108 may be integrated with the merchant front-end component 104 or may also be installed on the user device 204 as another app. Thus, effectively, the user device 204 and the payment gateway system 208 may be integrated/implemented on a single device.

In another example implementation, consider the merchant system 206 to be a web server and the merchant back-end component 106 to be an e-commerce marketplace website hosted on the web server, which can be accessed by the user device 204 over the communication network 202. In this example, the payment gateway component 108 can be integrated/implemented on the same web server. Thus, effectively, the merchant system 206 and the payment gateway system 208 may be integrated/implemented on a single system while the user device 204 may be implemented as a separate device.

Similarly, other example implementations of the network environment 200 implementing a system for facilitating authentication for online payment will be evident to a person skilled in the art from the present disclosure and are intended to be covered in the scope of this disclosure and the appended claims. Accordingly, the term system for facilitating authentication for online payment may refer to any one of the devices or systems which have at least the payment gateway component 108 installed therein.

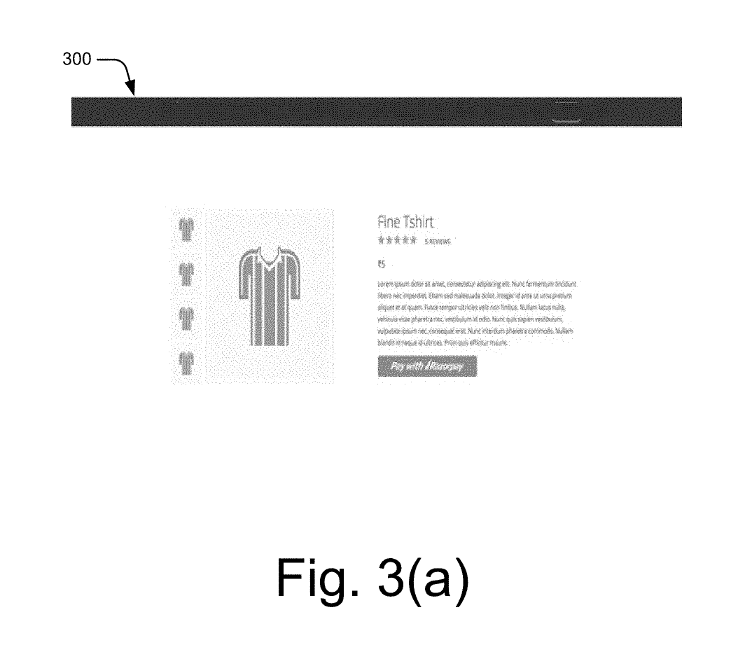

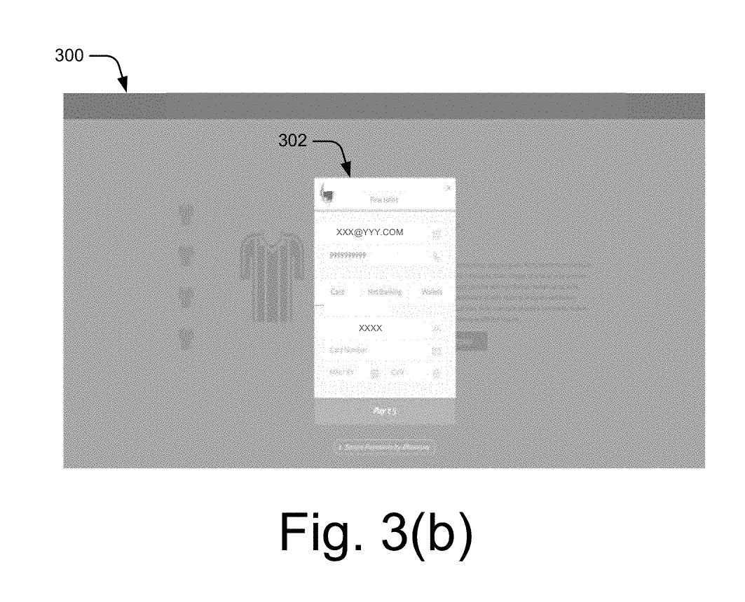

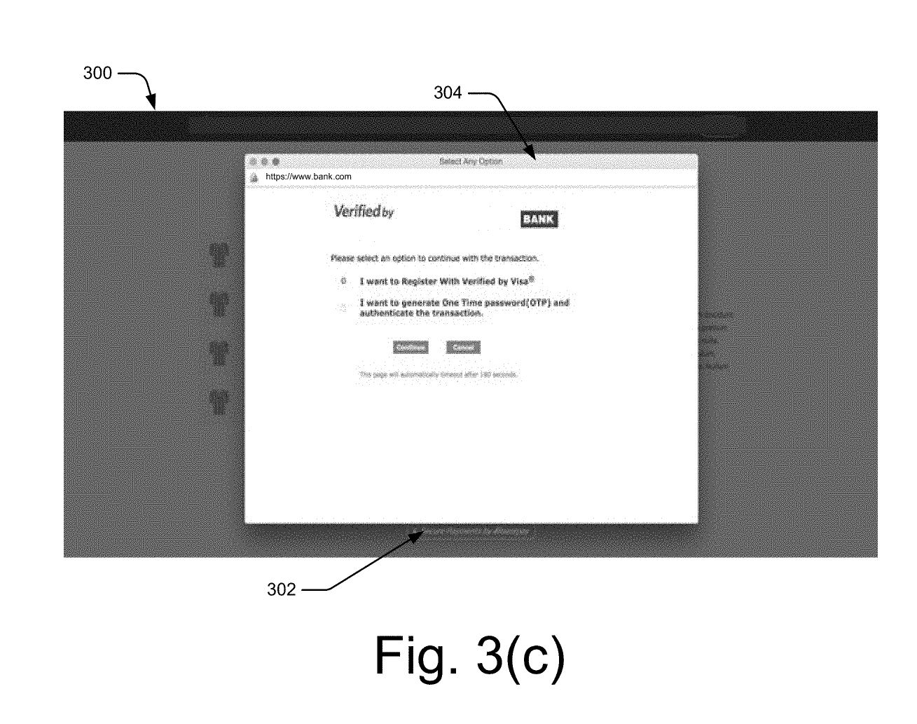

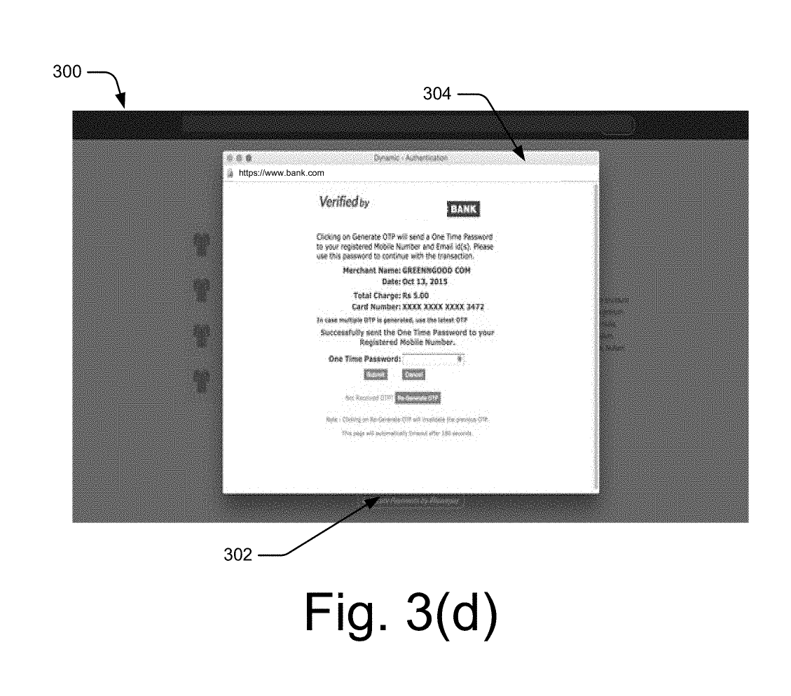

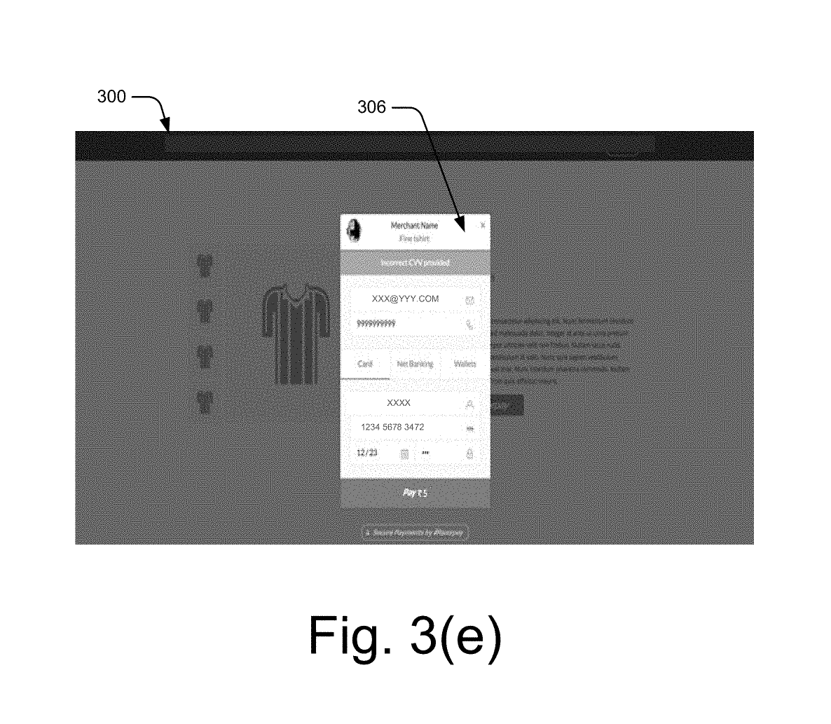

FIGS. 3(a) to 3(e) illustrate screenshots of user interface 102 during authentication of online payments, in accordance with various implementations of the present subject matter and are to be understood in the context of the example implementations discussed above with reference to FIGS. 1(a), 1(b), and 2.

FIG. 3(a) illustrates an example of merchant web page 300 where the user can buy a product. On selecting an item to be purchased, the user may be presented with a web page for payment, referred to as a first web page 302. FIG. 3(b) illustrates an example of the first web page 302 overlaid over the merchant web page 300. The first web page 302 is a payment details page. The details provided by the user may be stored in or fetched from the user data 222 if requested by the user. In an implementation, the payment details may be collected on the merchant web page 300 itself, instead of a popup from the merchant web page 300. In this case, the first web page 302 would be displayed as part of the merchant web page 300.

As discussed above, in response to receiving the payment details, the user may be presented a second web page 304, as illustrated in FIG. 3(c). Thus, the first web page 302 may be kept open in the background, and, the payment details filled in the first web page 302 may be retained. The second web page 304 may be a popup window or an iframe space inside the first web page 302 itself. Further, in an implementation, the first web page 302 and the second web page 304 may be implemented using JavaScript APIs. Thus, there is no redirection involved in moving from the first web page 302 to the second web page 304 for the second level of authentication.

In accordance with the present subject matter, the second web page 304 may correspond to the second step of authentication. As a part of the second step of authentication, the user may select a first option, such as 3D secure password or a second option, such as an OTP. It will be appreciated that password and OTP are provided as examples, and other equivalent authentication options may also be implemented.

FIG. 3(d) illustrates a scenario in which the user selects the second option, in accordance with an implementation of the present subject matter. However, it will be appreciated that the first web page 302 may be provided in the background irrespective of the mode of authentication being selected by the user.

Upon successful authentication in the second web page 304, the transaction may be completed. Further, the user may be presented with details of the transaction on the merchant web page 300. The details of the transaction may correspond to details of the product purchased, amount of money paid, delivery details, mode of payment details, and the like.

However, in case of authentication failure, a modified first web page 306 may be provided to the user. FIG. 3(e) illustrates a modified first web page 306 in case of a transaction failure at the second step of authentication in the second web page 304. As may be observed, the modified first web page 306 may have the payment details as previously filled by the user in the first web page 302. Further, the user may be presented with an indication that the transaction failed. Furthermore, the user may be provided an option of retrying to complete the transaction. The reason for failure of transaction, for example, failure in network connection, server not responding, wrong credentials, and the like, may also be indicated. In one example, a retry button may be displayed on the modified first web page 306. Thus, the user can easily resend the payment details without having to fill-in the payment details.

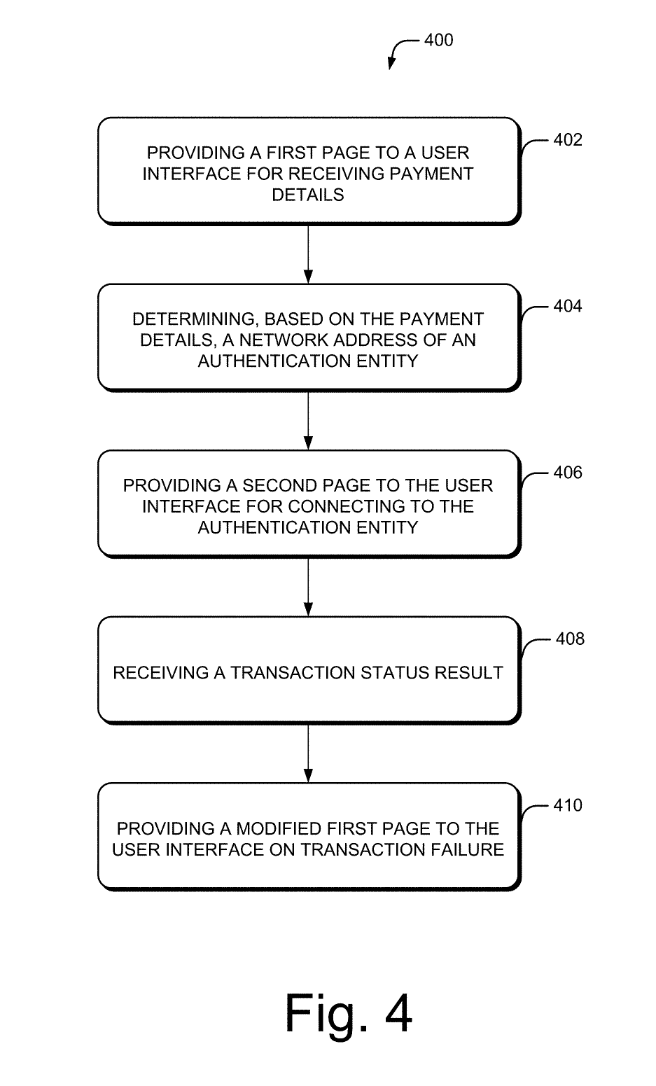

FIG. 4 illustrates a method 400 for facilitating online payment, in accordance with an implementation of the present subject matter. The method 400 can be implemented in a computing system. The order in which the method 400 is described is not intended to be construed as a limitation, and any number of the described method blocks can be combined in any order to implement the method 400, or any alternative methods. Additionally, individual blocks may be deleted from the method 400 without departing from the spirit and scope of the subject matter described herein. Furthermore, the method 400 can be implemented in any suitable hardware.

The method 400 may be described in the general context of computer executable instructions. Generally, computer executable instructions can include routines, programs, objects, components, data structures, procedures, modules, functions, etc., that perform particular functions or implement particular abstract data types. Further, although the method 400 may be implemented in any computing system; in an example described in FIG. 4, the method 400 is explained in context of the aforementioned network environment 200, for the ease of explanation.

Referring to FIG. 4, at block 402, a first page requesting payment details for a first level of authentication is provided to user interface 102 by the merchant front-end component 104 or the payment gateway component 108. The payment details include, for instance, card number, card verification value (cvv), and expiry in case of credit/debit cards. It could also be bank selection in case of net banking. Additionally, it could be details for a digital wallet in case of payment via a digital wallet. In an example, the first page may be part of a merchant web page.

Next at block 404, based on the payment details, a network address of an authentication entity for performing the second level of authentication is identified from a payment-processing infrastructure 110.

At block 406, a second page may be presented for connecting to the authentication entity without redirecting from the first web page. The second page is provided while keeping the first page open in the merchant front-end component 104 with the payment details populated therein.

Next, at block 408, a transaction result status is received from the payment-processing infrastructure 110. The transaction result status is indicative of a combined result of the first level of authentication, the second level of authentication, and the online payment.

At block 410, when the transaction result status indicates failure, the first page is modified to provide a modified first page to the user interface 102. The modified first page includes the payment details previously populated for the online payment and thus the user does not have to re-enter all the details, saving time and resources and reducing abandonment of transactions.

The present subject matter thus provides for efficient utilization of computational resources. For instance, as there may be no redirects to new web pages for receiving the payment details from the user, in case of failures, multiple web pages may not be required for the same transaction. Thus, the complete transaction may be handled through one page itself. Lesser redirects amount to lesser chances of failure due to network issues, etc. Further, in case of payment failure, the payment details may be retained temporarily on the first page itself at the user interface 102 end. For example, the payment details may be retained in the web browser or the app on the user interface 102 without being stored in the user device 204 or the merchant end. Thus, the merchant does not need to implement any card/banking information saving feature, which requires PCI compliance. Furthermore, the user can easily retry a payment, which may provide for positive user experience. The above-mentioned features, directly lead to an increase in transaction success rates since the friction for online payments is reduced.

Although implementations for system(s) and method(s) for facilitating authentication for online payment are described herein, it is to be understood that the present subject matter is not necessarily limited to the specific features or methods described herein. Rather, the specific features and methods are disclosed as implementations to perform the authentication for online payment.

I/We claim:

1. A method for authentication for an online payment, the method comprising:
providing a first page to a user interface of a user device for receiving payment details for the online payment for a first level of authentication;
determining, based on the payment details, a network address of an authentication entity in a payment-processing infrastructure;
providing a second page to the user interface for connecting to the authentication entity for a second level of authentication while keeping the first page open in the user interface with the payment details populated in the first page;
receiving a transaction result status, wherein the transaction result status is indicative of a result of the first level of authentication, the second level of authentication, and the online payment; and
when the transaction result status indicates failure, modifying the first page to provide a modified first page to the user interface, wherein the modified first page includes the payment details previously populated for the online payment.

2. The method as claimed in claim 1, further comprising
receiving an order information from a merchant page in a merchant front-end component, the order information indicating an order to be fulfilled;
generating a purchase initiation request based on the order information, the purchase initiation request indicating at least an amount to be paid; and
providing the first page based on the purchase initiation request.

3. The method as claimed in claim 1, wherein modifying the first page comprises at least one of adding a retry button and adding a field indicating a reason for transaction failure.

4. The method as claimed in claim 1, comprising, prior to modifying the first page, closing the second page if the second page is determined to be open.

5. The method as claimed in claim 1, wherein when the transaction result status indicates success, the method comprises closing the second page in the user interface and providing a transaction success message.

6. The method as claimed in claim 1, comprising
receiving a message from the authentication entity, based on the payment details, that the second level of authentication is not to be performed; and
receiving the transaction result status, wherein the transaction result status is indicative of a result of the first level of authentication and the online payment.

7. A system for 3D secure authentication for online payment, the system comprising:
a processor;
a payment gateway component coupled to the processor to authenticate online payment, wherein the payment gateway component is to:
determine, from a payment-processing infrastructure, a network address of an authentication entity, based on payment details received from a first page on a user interface;
provide a second page to the user interface for connecting to the authentication entity for a 3D secure authentication, wherein the second page is to be presented in addition to the first page while the first page remains open with the payment details populated in the first page;
receive a transaction result status from the payment-processing infrastructure based at least on the payment details and the 3D secure authentication, wherein the transaction result status is indicative of result of the online payment; and
when the transaction result status indicates failure, causing modification of the first page to provide a modified first page to the user interface, wherein the modified first page includes the payment details previously populated for the online payment.

8. The system as claimed in claim 7, wherein the payment gateway component is to receive a purchase initiation request from one of a merchant back-end component and a merchant front-end component, the purchase initiation request indicating at least an amount to be paid, and provide the first page to the user interface in response to the purchase initiation request.

9. The system as claimed in claim 7, wherein the payment gateway component adds at least one of a retry button and a field indicating a reason for transaction failure to the first page to provide the modified first page.

10. The system as claimed in claim 7, wherein the payment gateway component, prior to causing modification of the first page, closes the second page if the second page is determined to be open.

11. The system as claimed in claim 7, wherein, when the transaction result status indicates success, the payment gateway component is to close the second page in the user interface and provide a transaction success message to a merchant back-end component.

12. The system as claimed in claim 7, wherein the first and second pages are one of web pages and app pages.

13. The system as claimed in claim 7, wherein the first and second pages are individually selected from one of popup and iframe.

14. The system as claimed in claim 7, wherein the first and second pages are implemented with JavaScript code.

15. The system as claimed in claim 7, further comprising a merchant back-end component coupled to the processor to provide merchant pages to a merchant front-end component, wherein the payment gateway component is associated with one or more of the merchant pages using JavaScript code.

16. The system as claimed in claim 7, further comprising a merchant front-end component to receive a purchase initiation request from a merchant back-end component, the purchase initiation request indicating at least an amount to be paid, and provide the first page to the user interface in response to the purchase initiation request.

17. The system as claimed in claim 16, further comprising the user interface to allow a user to interact with the merchant front-end component and the payment gateway component.

18. A non-transitory computer-readable medium comprising instructions for facilitating authentication, the instructions being executable by a processing resource to:
receive order information from a merchant page in a user interface, the order information indicating an order to be fulfilled;
generate a purchase initiation request indicating at least an amount to be paid, based on the order information;
provide a first page to the user interface based on the purchase initiation request for receiving payment details for a first level of authentication for an online payment;
in response to receiving the payment details, provide a second page to the user interface for connecting to a payment-processing infrastructure for a second level of authentication while causing to keep the first page open in the user interface with the payment details populated in the first page;
receive a transaction result status from the payment-processing infrastructure, wherein the transaction result status is indicative of a result of the first level of authentication, the second level of authentication, and the online payment;
when the transaction result status indicates failure, modify the first page to provide a modified first page, wherein the modified first page includes the payment details previously populated for the online payment and at least one of a retry button and a field indicating a reason for transaction failure; and
when the transaction result status indicates success, provide a transaction success message to the user interface.
